(19) United States
(12) Patent Application Publication
(10) Pub. No.: US 2024/0368421 A1
(43) Pub. Date: Nov. 7, 2024

(54) MOLD COMPOSITION COMPRISING A SUGAR COMPONENET

(71) Applicant: PROIONIC GMBH, Grambach (AT)

(72) Inventors: Roland S. KALB, Sinabelkirchen (AT); Ladislav KONCIK, Leoben (AT); Michael STEINER, Trieben (AT)

(21) Appl. No.: 18/775,278

(22) Filed: Jul. 17, 2024

Related U.S. Application Data
(63) Continuation of application No. 17/414,576, filed on Jun. 16, 2021.

(30) Foreign Application Priority Data
Dec. 20, 2018 (EP) 18214602.7

(51) Int. Cl. C09D 105/00; B22C 9/04; B29C 33/52; C04B 35/10; C04B 35/52; C04B 35/645; C09D 7/40; C09D 7/61

(52) U.S. Cl. CPC C09D 105/00; B22C 9/04; B29C 33/52; C04B 35/10; C04B 35/522; C04B 35/6455; C09D 7/61; C09D 7/70; B29K 2805/00; C04B 2235/3217; C04B 2235/425; C04B 2235/602

(57) ABSTRACT

A moulding composition comprising at least one sugar component in a weight proportion of at least 20% in relation to the weight of the moulding composition, and at least one aggregate as well as a mould for a moulding process, wherein the mould is a compact three-dimensional structure made of the moulding composition, and a process for moulding a workpiece with the mould.

### CROSS REFERENCE TO RELATED APPLICATIONS

This Application is a continuation of U.S. patent application Ser. No. 17/414,576, filed Jun. 16, 2021, which is a 371 of International Application No. PCT/EP2019/086692, filed Dec. 20, 2019, which claims the benefit of European Patent Application No. 18214602.7, filed Dec. 20, 2018, which are incorporated herein in their entirety.

### BACKGROUND OF THE INVENTION

The invention relates to a moulding composition comprising at least one sugar component, a mould for a moulding process made of this moulding composition, and a process for moulding a workpiece with a mould.

Moulds, in particular lost moulds, are used for the moulding of workpieces in various moulding processes, for example, in the production of metallic, ceramic or polymeric workpieces by pressing, transfer moulding, casting, injection moulding, powder injection moulding processes or, in case of fibre composite workpieces, by lamination processes. In this connection, the mould is typically a negative of at least part of the three-dimensional configuration of a workpiece.

The term “mould”, as used herein, refers to a model, in particular a lost mould, a lost mould core or a support structure.

Metallic, ceramic or polymeric workpieces with complex shapes—e.g., with cavities or so-called undercuts—usually cannot be implemented by pressing processes or casting processes with demouldable or, respectively, removable tools because internal or undercut moulded parts cannot be removed at the end of the moulding process for mechanical reasons. In order to be able to produce such workpieces, so-called lost moulds or, respectively, lost mould cores are used in the art, which can be removed by being dissolved in water or other liquids, by being melted out or by thermal decomposition or, respectively, combustion, with liquid, gaseous or pourable, powdery decomposition products being formed. In other cases, a removable tool is technically feasible, but is uneconomical in comparison to a lost mould.

### 1. Lost Core Injection Moulding

In the injection moulding process, primarily plastic materials (polymers) are processed: in most cases, thermoplastic but also thermosetting or elastomeric plastic powders, granules or pastes are heated to 150-300° C. in a heated cylinder with a piston or a rotating screw (extruder) until they are plasticized, compressed and then injected into a shaping, water-cooled, generally steely, two-part cavity at pressures of 500-2000 bar. After cooling and hardening or vulcanization, the workpiece can be removed by opening the cavity. In order to be able to produce workpieces with cavities or undercuts, lost moulds or, respectively, mould cores are used also in this case: On the one hand, those cores are manufactured from low-melting metal alloys (fusible alloys) such as Wood's metal or Rose's metal by casting, which are removed from the injection moulding by being melted out, or they consist, for example, of water-soluble polyacrylate polymers, which, in turn, have been produced by injection moulding. Lost core injection moulding may also be used for the production of fibre-reinforced plastic workpieces, see, e.g., EP 1 711 334 A2. When melting out fusible alloys, care must be taken that the metallic mould core is stable and malleable at the selected injection moulding temperature for a sufficient amount of time and that, later, the synthetic workpiece will not be thermally affected at the necessary melting temperature (Michaeli, W.; Greif, H.; Kretzschmar, G.; Ehrig, F., Technologie des Spritzgießens, 3^{rd} edition; Hanser: Munich, 2009).

### 2. Powder Injection Moulding

A further development of the above-described injection moulding process for plastic materials is the so-called powder injection moulding, which is used for sinterable powders such as metallic powders, also referred to as metal injection moulding (typically sintered ferrous and non-ferrous metals, hard metals, composite materials made of metal), for ceramic powders, also referred to as ceramic injection moulding (typically ceramics (cermets), oxide ceramics, nitride ceramics, carbide ceramics and functional ceramics), Gr and for special polymeric powders such, e.g., as teflon. In these processes, injection moulding materials consisting of metallic, ceramic or polymeric particles (or of mixtures of such particles), auxiliary substances such as lubricants and (organic) binders are used. After injection moulding, the so-called green body is largely removed by dissolving the binder in water or suitable solvents or by a thermal treatment. Finally, the almost binder-free brown body thus formed is sintered in a material-specific, thermal process to form the finished workpiece. In a modification of this process, special binders may also remain deliberately in the green body in order to modify the properties of the workpiece. Using powder injection moulding, composite materials, e.g., fibre composite materials, can be produced as well. Analogously to the underlying normal injection moulding—as described above—lost moulds or, respectively, mould cores may also be used in powder injection moulding in order to be able to produce workpieces with cavities and undercuts (“Powder injection moulding”; Volker Piotter et al., Wiley Encyclopedia of Composites, 2^{nd} Edition (2012), 4, 2354-2367; “Recent Advances in CIM Technology”; B. S. Zlatkov et al., Science of Sintering, 40, 2008, 185-195).

### 3. Pressing

Sinterable metallic, ceramic or polymeric powders, for example, as described in 2. Powder injection moulding, can be processed into workpieces also by discontinuous pressing methods, whereby composite materials, e.g., fibre composite materials, can likewise be produced. For this purpose, moulding compounds consisting of ceramic, metallic or polymeric particles, auxiliary materials such as lubricants and (organic) binders are produced analogously and are introduced into press moulds (press dies) made of wear-resistant steel or hard metals. The moulding compounds can be processed in a dry (dry pressing) or wet (wet pressing), cold (cold pressing), warm (hot pressing) or hot state (pressure sintering). By shaking (vibratory compaction), a uniform distribution—particularly important for complex shapes—and initial compaction of the moulding compound can be achieved. By means of a press ram (uniaxial pressing) or several press rams (coaxial pressing), a green body is produced from the moulding compound at pressures of a few 100 bar up to 10,000 bar. In contrast to liquids, the pressure does not spread evenly in all directions in this case, and the lateral material flow is low; the resulting compaction of the green body thereby decreases due to internal frictional forces and friction with the press mould as the distance from the press ram(s) increases.

In order to avoid this disadvantage, the so-called isostatic pressing is applied more and more often: In this process, the moulding compound to be pressed—which is dry and powdery in most cases—is placed in a closable elastic mould (e.g., made of polyurethane, silicone or rubber) and is pre-compacted usually by shaking (vibratory compaction). The mould is then introduced into the so-called recipient (a pressure-resistant, closable vessel) filled with a liquid (usually water, oil or oil-water mixtures, less often gas), which is closed. By raising the pressure in the recipient to a few 100 up to a few 1,000 bar by means of a hydraulic system (compressors in case of gas), the mould is then pressed isostatically from all sides due to the uniform pressure distribution in the liquid or gas so that the compaction will not take place axially, but from the outside toward the inside. Furthermore, the particles to be compacted cover a much shorter distance during the isostatic pressing than in axial pressing methods. As a result, the emerging green body will have its highest compaction and thus, after sintering, also its highest strength on the surface where this will also be needed in the finished workpiece, with the density distribution and the resulting strength distribution having a significantly lower gradient than in axial pressing methods. Isostatic pressing usually takes place in a cold state (cold isostatic pressing), but can also be performed in a hot state (hot isostatic pressing) when gases are used as pressure media, for example, argon, and clastic moulds made of metal containers (so-called capsules) are used, whereby, in the latter case, pressure sintering is already possible as well. After the isostatic pressing process, the excess pressure of the pressure medium is released and the green body is removed from the clastic mould. The further treatment to form the sintered final product is done analogously to 2. powder injection moulding, wherein, also in this case, binders can be removed by subsequent process steps or may remain deliberately in the green body.

Analogously to the above-described processes, lost moulds or, respectively, mould cores made of water-soluble, meltable or burnable substances can be used also for uniaxial, coaxial or isostatic pressing in order to be able to produce workpieces with cavities and undercuts. Depending on the requirements of the pressing process (pressure, temperature), the sinter materials used, the shape of the workpiece, etc., mould cores made, for example, of low-melting metals, salts, waxes, foamed or compact plastic materials or other disintegratable materials are used also in this case (“Einführung in die Pulvermetallurgie; Verfahren und Produkte”; 6th edition, 2010; brochure of the European Powder Metallurgy Association (EPMA), SY2 6LG Shrewsbury, United Kingdom; available at the Fachverband Pulvermetallurgie e.V., 58093 Hagen, Germany; www.pulvermetallurgic.com).

### 4. Investment Casting

In the investment casting process, lost models of the workpiece are produced from special meltable or water-soluble waxes (e.g., based on polyethylene glycol or polyacrylate) or burnable thermoplastics (e.g., made of foamed polyurethane or polystyrene) in an injection moulding technique with aluminium or steel tools, for example. In order to create cavities or undercuts, such a model can be provided additionally with water-soluble, meltable or burnable lost cores. The model is then dipped in a so-called slip, a ceramic mass for the production of a mould shell consisting of a fireproof fine powder and a binding agent, e.g., ethyl silicate. The model covered with slip is then sprinkled with sand and dried. Dipping and sanding is repeated until the fireproof mould shell has achieved the required stability. Water-soluble cores are then extracted in a water bath; meltable cores are removed by a thermal treatment with water vapour, for example. The mould shells are then fired at approx. 750-1200° C., with burnable cores or core residues being removed completely. This is followed by the actual metal casting (e.g., steels and alloys based on iron, aluminium, nickel, cobalt, titanium, copper, magnesium or zirconium) into the ceramic mould shell and post-processing of the cooled workpiece. The castings thus obtained are characterized by their level of detail, dimensional accuracy and surface quality. Investment casting mostly serves niche markets in the high-performance segment with smaller quantities (“ Feinguss: Herstellung, Eigenschaften, Anwendung ”; brochure of the Federal Association of the German Foundry Industry, 2015, www.kug.bdguss.de; Foundry-Lexicon. 19^{th} edition, Stephan Hasse, 2007; Verlag Schiele und Schön, ISBN 978-3794907533).

### 5. Lamination of Fibre-Plastic Composite Materials

Modern fibre-plastic composite materials are composed of a matrix (e.g., made of thermosetting plastics such as, e.g., synthetic resins, less often thermoplastics) and several superimposed layers of fibre fabrics, laid fabrics, knitted fabrics, mats, fleeces, etc. with different main fibre directions. In this connection, particularly tear-resistant fibres such as glass fibres, carbon fibres, ceramic fibres, polyaramid fibres, steel fibres, polyamide fibres, polyester fibres, cellulose fibres, etc. are used. In the manual lamination technique, the fibres are placed on a moulded body and soaked with the matrix which has not been hardened/solidified yet. By pressing on with a roller, the layer is compacted, deaerated and excess matrix is removed. This process is repeated layer by layer until the desired material thickness is achieved. Thereupon, the workpiece is hardened thermally at a normal pressure or in a vacuum until the matrix material has cured. Other automatable lamination processes are resin transfer moulding (RTM), high pressure resin transfer moulding (HP-RTM) and structural reaction injection moulding (SRIM).

Also in this case, lost moulds are used for complex workpiece geometries with cavities and undercuts. An example of this are carbon-fibre reinforced mountain bike handlebars which are produced according to the process of the CAVUS project (see http://www.polyurethanes.basf.de/pu/solutions/de/content/group/innovation/concepts/Cavus and http://www.ktm-technologies.com/projekte/cavus): In this process, lost moulds and mould cores made of sand-binder mixtures are used in order to be able to produce the extremely lightweight, but high-strength mountain bike handlebars which have complex shapes and are hollow inside. In doing so, the lost mould core is covered with a knitted carbon-fibre tube and processed at 200 bar in an HP-RTM process within a few minutes into the finished workpiece. The lost core is then removed in a water bath, whereby the water-soluble binder is dissolved.

Depending on the process (1.-5.), lost moulds are thus formed, according to the prior art, from metals or alloys with low melting temperatures, from thermoplastic materials or from waxes. Those materials have a number of disadvantages as such or when they are processed:

Low-melting alloys such as Wood's metal, Rose's metal, etc. are reusable to a limited extent, but due to the heavy metals they contain, such as lead and cadmium, they are toxic. The relatively high density makes handling difficult because of the high weight, especially in case of large mould core volumes. Modern fusible alloys that are free of heavy metal and are based, for example, on indium, bismuth and tin are nontoxic, but their price is significantly higher by orders of magnitude.

TABLE 1
Properties of low-melting metals and fusible alloys

| | melting | tensile | modulus of | density | |
|---|---|---|---|---|---|
| | point | strength | elasticity | 25° C. | hardness |
| Metal or, respectively, alloy | [° C.] | [MPa] | [GPa] | [g/cm³] | Brinell |
| Bi48-Pb25.63-Sn12.77-Cd9.6 | 65 | 34 | 13 | 9.50 | 11 |
| fusible alloy | | | | | |
| Bi55.5-Pb45.5 fusible alloy | 124 | 44 | | 10.50 | 10.2 |
| Bi58-Sn42 fusible alloy | 139 | 55 | | 8.72 | 22 |
| Sn60-Bi40 fusible alloy | 170 | 55 | | 8.20 | 22 |
| Bi50-Pb26.7-Sn13.3-Cd10 | 70 | 41 | | 9.38 | 9.2 |
| fusible alloy | | | | | |
| Bi32.5-In51-Sn16.5 fusible alloy | 60 | 33 | | 7.88 | 11 |
| Bi | 271 | 14 | 32 | 9.80 | 7 |
| Pb | 328 | 18 | 14 | 11.35 | 4.2 |
| Sn (β) | 231 | 21 | 43 | 7.29 | 3.9 |
| In | 157 | 4.5 | 11 | 7.30 | 0.9 |

Sources: http://www.matweb.com; Journal of Biomechanical Engineering, 2006, 128, 161;
https://www.azom.com/properties.aspx?ArticleID=590;
Properties of Lead-Free Solders, NIST Database Release 4.0, 2002:
https://www.msed.nist.gov/solder/NIST_LeadfreeSolder_v4.pdf

Table 1 shows mechanical properties of such fusible alloys and some of their alloy components. The pure metals lead, tin and indium are generally unsuitable as mould core materials because of their softness, pure indium is far too expensive. Pure bismuth is significantly harder and therefore suitable for mould cores, but, as already mentioned, it is also quite expensive; furthermore, it is comparatively brittle and can break relatively easily. The above-listed fusible alloys indeed show hardnesses that are relatively good, however, they are either toxic (alloy components Pb, Cd) or very expensive (alloy components In). Bismuth-tin alloys seem to be quite well suited (hardness, tensile strength, toxicity), but are also in the price range of 100-200 euros/l. Besides lead and cadmium, indium and bismuth are also classified as “Hazardous waste according to the Waste Catalog Ordinance (AVV [Abfallverzeichnis-Verordnung])” as per the GESTIS database of the Institute for Occupational Safety and Health of the German Social Accident Insurance (http://gestis.itrust.de) and thus generate disposal costs. As is known to a person skilled in the art, melts of the above-mentioned metal alloys show maximum viscosities of a few mPa·s, which, together with the high density, facilitates draining also from cavities with narrow cross-sections when the lost moulds or, respectively, mould cores are being melted out. Nevertheless, it is to be expected that metallic residues cannot be avoided, which may lead to problematic metal and metal oxide vapours during processing at the necessary more or less high temperatures of the various shaping processes (especially in case of alloys containing heavy metal) and also burden the final product.

In comparison to the aforementioned metals, lost moulds and mould cores made, for example, of thermoplastic materials are cheaper by orders of magnitude so that, in contrast to metals, a single use might be economical. The density of suitable plastic materials ranges from approx. 0.9 to 1.2 g/cm³ (see Table 2) and is thus significantly below that of metal alloys, whereby handling of large mould cores is facilitated.

TABLE 2
Properties (reference values) of selected plastic materials

| | melting | | modulus | |
|---|---|---|---|---|
| | temper- | tensile | of | density |
| | ature | strength | elasticity | 25° C. |
| Plastic material | [° C.] | [MPa] | [MPa] | [g/cm³] |
| Acrylonitrile/butadiene/ | 110 | 45 | 2300 | 1.04 |
| styrene (ABS) | | | | |
| Polyamide 6 (PA6) | 220 | 45 | 1000 | 1.14 |
| Polyamide 66 (PA66) | 260 | 50 | 1100 | 1.14 |
| High-density polyethylene | 135 | 30 | 1350 | 0.96 |
| (PE-HD) | | | | |
| Polypropylene homopolymer | 163 | 33 | 1450 | 0.90 |
| (PP-H) | | | | |
| Polystyrene (PS) | 100 | 55 | 3200 | 1.05 |
| Polycarbonate (PC) | 148 | 66 | 2400 | 1.20 |
| Polyurethane compact | 98 | 37 | 1250 | 1.20 |
| (PUR 5217) | | | | |
| Polymethyl methacrylate | 110 | 73 | 3200 | 1.19 |
| (PMMA) | | | | |

Sources: https://www.kern.de/de/richtwerttabelle

The tensile strengths of plastic materials tend to be higher than those of metal alloys, the modulus of elasticity indicates a significantly better elasticity with values that are lower by two powers of ten, which, in case of anisotropic pressure conditions during the moulding of a moulded part in the above-described processes, leads, on the one hand, to higher mechanical stability of the lost mould core (structures are torn off by shear forces with less ease), but, on the other hand, may result in larger deviations from the desired geometry of the workpiece. In contrast to metallic lost mould cores, mere melting and draining in order to remove them from the workpiece is not possible, since the naturally high viscosities of plastic melts (high molecular weights) with approx. 100 to several 1000 Pa·s are above those of the previously described metals by 5-6 powers of ten (Kunststoff-Taschenbuch; Oberbach, Saechtling, 28^{th} edition, Hanser München 2001, ISBN 978-3-446-21605-1). Therefore, in order to be able to completely remove mould cores made of plastic, they either a.) must be dissolvable in a solvent or b.) must be completely decomposed into gaseous components at high temperatures (a protective gas which is necessary, for example, for sintering carbon-containing ceramics or carbides; often not successful as charring occurs) or burnt (air).

In order to enable that the dissolving of water-soluble plastic materials or other plastic materials in organic solvents is economical, it must take place quickly enough and the disposal costs or reprocessing costs of the resulting solution must be kept within acceptable limits. Since the solutions of plastic polymers also have high viscosities, the dissolution process is, as expected, relatively slow, especially if it can no longer be accelerated by a mechanically produced turbulent flow or a thermally produced turbulent convection. This applies also if the material has to change direction several times when it is dissolved and extracted from the cavity. In case of cavity or undercut structures of the tool to be produced, which are, for example, deep inside, i.e., are at a great distance from the surface or have very small cross-sections, the dissolution process becomes more and more diffusion-controlled and therefore slower and slower.

The thermal decomposition or burning of plastic mould cores is only possible if the workpiece can withstand the temperature, duration and atmosphere (oxidative, inert, reductive) necessary therefor. During the decomposition process itself, large amounts of hot gases naturally arise, which must be able to escape freely from the cavities or undercuts of the workpiece, since, otherwise, the resulting pressure may cause the workpiece to be damaged or destroyed. Due to the high viscosity of the polymer melt formed prior to the thermal decomposition, problems may arise in narrow and/or winding or complex cavity or undercut structures of the tool to be produced, which communicate with each other, if the gases are impeded or prevented from escaping by blocking areas that are still molten.

In principle, the thermal removal of lost plastic mould cores involves the necessity of a post-treatment of the decomposition gases that arise and usually contain toxic components (e.g., NOx in polyurethanes, polycyclic aromatics, monomers, etc.).

Mould cores made of water-soluble waxes (e.g., based on polyethylene glycol) or water-insoluble waxes (e.g., paraffins) can be used at low pressures only to a very limited extent because of their softness, for example, in investment casting.

It is therefore the problem to provide a composition which overcomes the above-described disadvantages and can be used as a lost mould in various processes. This means that a mould can be produced from the composition which exhibits both good mechanical stability and, at the same time, the best possible removability.

### SUMMARY

The problem is solved by a moulding composition comprising
at least one sugar component in a weight proportion of at least 20%, preferably at least 50%, particularly preferably at least 80%, in relation to the weight of the moulding composition, and
at least one aggregate.

The problem is also solved by a mould for a moulding process, the mould being a compact three-dimensional structure made of the moulding composition according to the invention. This means that a moulding composition according to the invention can be used as such (without further additives) for the production of a mould.

In a further aspect, the invention relates to a process for moulding a workpiece, comprising the steps of
providing at least one mould,
contacting the mould with a material to be moulded,
hardening the material to be moulded in order to obtain the workpiece,
removing the mould from the workpiece,
   characterized in that the at least one mould is a mould according to the invention, that is to say, a compact three-dimensional structure made of a moulding composition according to the invention.

The moulding composition according to the invention comprises a sugar component as an essential component, preferably as the main component in terms of quantity.

The sugar component is understood to be a mono-, di- or oligosaccharide (sugars/saccharides) or, respectively, a sugar alcohol derived from such a saccharide, a hydrate of a sugar or of a sugar alcohol or a mixture thereof. Sugars and sugar alcohols are very inexpensive, nontoxic and readily available substances which have long been known and are widely used in the field of food production as sweeteners or in the production of pharmaceutical preparations, for example, as compressible matrices or other auxiliaries (“Pharmazeutische Hilfsstoffe”; Schmidt, Lang, 2013, Govi-Verlag Pharmazeutischer Verlag GmbH, Eschborn, ISBN 978-3-7741-1298-8).

It has now been found that a composition comprising a sugar component can be provided as a compact three-dimensional structure and is suitable as such as a mould for various moulding processes, for example, in the process according to the invention for moulding a workpiece. Due to their glass-like surface, low porosity, high strength, low density and good malleability, moulds made of the moulding composition according to the invention have proved to be suitable for the transfer of a three-dimensional outline when the mould is being contacted with a material to be moulded, for example, in the production of ceramic workpieces. The moulds can be used in particular for reproducing internally located areas such as undercuts and cavities, as they are easily melted out, burnt out or dissolvable with hydrophilic solvents such as water due to the sugar component. The mould is thus used preferably as a lost mould. Furthermore, the sugar components are very inexpensive, readily available, nontoxic and easily disposable (commercial waste, sewage treatment plant).

The structure of the mould is obtained if the moulding composition is provided as a (cooled) melt or a compressed structure. The moulding composition can be brought into shape by melting the sugar component, mixing it with the aggregate (or vice versa) and casting the moulding composition, e.g., by casting it into appropriate silicone moulds, in order to obtain mechanically stable moulds after cooling. Other processes that are conceivable comprise injection moulding, 3D printing or even direct pressing without prior melting. These processes are known in the field of food production (e.g., hard caramels) or in the pharmaceutical industry.

Furthermore, the moulding composition according to the invention and the mould according to the invention comprise at least one aggregate.

The aggregate has the surprising effect that the mould made of the moulding composition has an even higher mechanical strength. In particular, the formation and continuation of breaks in a structure made of the sugar component could be reduced by adding a comparatively small amount of an aggregate without impairing the malleability or other advantageous properties in comparison to a mould made of a sugar component only.

### BRIEF DESCRIPTION OF THE DRAWINGS

FIG. 1 shows, in a side view, two moulds, namely an internally located mould and an external mould.

FIG. 2 shows, in cross-section, the moulds being contacted with a material to be moulded before hardening (A), after hardening (B) and removing the external mould, and after post-hardening (C) and complete removal of the mould from the workpiece (D).

FIG. 3 shows the moulded workpiece in a side view.

### DETAILED DESCRIPTION

The term sugar component is to be understood according to the invention in such a way that it describes a mono-, di- or oligosaccharide (synonymous also for sugar or saccharide), a sugar alcohol derived from such a saccharide, a hydrate of such a saccharide or of a sugar alcohol or a mixture thereof. Those compounds can be summarized as a subgroup of carbohydrates which include, in their generic name, both saccharides and the sugar alcohols derived by reducing the carbonyl group (alditols) (IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. “carbohydrates”; doi: 10.1351/goldbook.C00820).

The prefix oligo denotes compounds between dimers and higher polymers. Typically, oligomeric structures have 3 to 10 repeating units (IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8., “oligo” doi: 10.1351/goldbook.O04282), and, also herein, the term oligosaccharide is intended to include carbohydrates made of 3 to 10 saccharide units. The sugar component can thus have 1-10 saccharide units.

The sugars or, respectively, sugar alcohols can be described as a compound of the general formula I

$${C}_{( n * a )} {H}_{( n * a * 2 ) + 2 b - 2 c} {O}_{( n * a ) - c} , \qquad ( I )$$

wherein
n is 1 to 10, preferably 1 or 2,
a is 4, 5 or 6,
b is 0 or 1, and
c is n-1 or n.

In monosaccharides or sugar alcohols derived from monosaccharides, n is 1, while in disaccharides or sugar alcohols derived from disaccharides, n is 2. In oligosaccharides, n is 3-10, depending on the number of repeating units.

For the respective repeating units, four carbon atoms (tetrose), five carbon atoms (pentose) and six carbon atoms (hexose) are included as variants, therefore, a can be 4, 5 or 6, preferably 4 or 6, even more preferably 6. While the term sugar component also includes mixed di- and oligosaccharides with regard to the number of carbon atoms of the individual repeating units, formula I is applicable only to those sugar components in which the repeating units have an equal number of carbon atoms.

In di- and oligosaccharides, one or several water molecules is/are formally split off as a result of the condensation. For each condensation, the molecular formula has two H less and one O less, which is reflected in formula I, because n is greater than 1 in di- and oligosaccharides and, therefore, a value for c greater than or equal to 1 yields as c equals n-1. This results in the formal subtraction of one H₂O molecule per condensation in formula I.

Cyclodextrins are a group of oligosaccharides with 6-8 glucose units that are linked 60 -1,4-glycosidically and form a ring. Another water molecule is split off as a result of the ring formation. In case of cyclic oligosaccharides, c therefore is n. α-Cyclodextrin with 6 glucose units has the molecular formula C₃₆H₆₀O₃₀, which means that it corresponds to Formula I with n is 6, a is 6, b is 0 and c is n is 6.

Sugar alcohols are derived from the respective sugar by reduction, which is formally expressed by two additional hydrogen atoms in the molecular formula. For sugar alcohols, b therefore is 1 in Formula I, while b is 0 for sugars, i.e., ketoses or aldoses.

In addition, a sugar component can be a hydrate of a saccharide or a sugar alcohol or, respectively, a compound of general formula I. Sugars such as, for example, glucose occur as anhydrous forms (anhydrates) or as hydrates. In this regard, the term “hydrate” can denote both a variant which contains water of crystallization and an organic hydrate in which water is bound by an addition reaction, as it may happen, for example, with aldoses. The anhydrous forms of the sugar components or compounds of formula I are preferred.

The at least one sugar component can also be a mixture of at least two saccharides or sugar alcohols or, respectively, compounds of general formula I or their hydrates.

Isomalt is a hydrogenated isomaltulose (Palatinose®), which consists of roughly equal parts of 6-O-α-D-glucopyranosyl-D-glucitol (GPS, isomaltitol) and 1-O-α-d-glucopyranosyl-D-mannitol (GPM). So, this is a preferred mixture of two sugar alcohols each derived from a disaccharide.

Mixtures are preferred especially if the mixture has a low melting point compared to the individual sugar components, i.e., so-called eutectic mixtures.

A mono-, di-, oligosaccharide (saccharide) or a sugar alcohol derived from such a saccharide or, respectively, a compound of general formula I can typically be present in different stereoisomers (enantiomers) due to the asymmetrically substituted carbon atoms. All conceivable enantiomers are covered by the general name or, respectively, formula, but the naturally occurring enantiomers are preferred in each case.

In a preferred embodiment, the at least one sugar component is selected from the group consisting of sucrose, D-fructose, D-glucose, D-trehalose, cyclodextrins, erythritol, isomalt, lactitol, maltitol, mannitol, xylitol and mixtures thereof.

The at least one sugar component typically has a decomposition temperature range and/or a melting point. The term decomposition temperature range describes a temperature range in which the sugar component softens, with a chemical decomposition, such as, e.g., a (strong) caramelization, taking place. During caramelization, different reactions occur also between the individual molecules of the sugar component, just like condensations and a polymerization and a cleavage of smaller molecules, so that the original sugar component is broken down. The final product of the thermal decomposition of a sugar component is CO₂ and water under oxidative conditions and carbon under reductive conditions. In practice, often no distinction is made between the decomposition temperature range and the melting point, and, in literature, both values are often indicated as mp for melting point. Herein, the melting point is to be defined as the temperature range at which the sugar component changes from the solid state to the liquid or, respectively, gel-like state without decomposition. The melting point as used herein includes both the transition from a crystalline solid state to a liquid and the transition from a glassy solid state to a liquid (also known as the glass transition temperature). Thus, a change in the viscosity of the sugar component occurs at the melting point. Typically, the viscosity drops by at least one power of ten, if the sugar component is heated from a temperature below the melting point to a temperature above the melting point.

In a preferred embodiment, the at least one sugar component has a melting point and a decomposition temperature range, wherein the melting point is below the decomposition temperature range.

Many sugars in their anhydrous form already decompose strongly below their melting point and caramelize in the process. Sucrose has a real melting point of 185-186° C., with decomposition starting at around 160° C. D-Fructose (mp 106° C.) or D-glucose (mp 146° C.) cannot be processed by melting, either, and are therefore not preferred as sugar components. By mutual eutectic mixtures, the melting points can be lowered to such an extent that this problem can be solved, e.g., sucrose (30 wt %)—glucose (mp 137° C.), sucrose (30 wt %)—fructose (mp 97° C.), glucose (27 wt %)—fructose (mp 93.2° C.) (see J. Appl. Chem., 1967, vol. 17, 125).

D-Trehalose (mp 214-216° C.), for example, can be melted without caramelizing and decomposes only at 284° C.; most anhydrous sugar alcohols such as erythritol (mp 122° C.), isomalt (mp 145-150° C.), lactitol (mp 144-146° C.), maltitol (mp 148-151° C.), mannitol (mp 165-168° C., Td 300° C.) or xylitol (mp 93-94.5° C.) also show no thermal decomposition far beyond their melting point and can thus be processed according to the invention (“Pharmazeutische Hilfsstoffe”; Schmidt, Lang, 2013, Govi-Verlag Pharmazeutischer Verlag GmbH, Eschborn, ISBN 978-3-7741-1298-8).

The particularly preferred sugar components therefore include D-trehalose, isomalt, erythritol, lactitol, mannitol and eutectic mixtures of sucrose and D-glucose.

In a preferred embodiment, the moulding composition is not hygroscopic or is hygroscopic only above a relative humidity of the ambient air of 80%.

The hygroscopic properties of the moulding composition, i.e., its characteristic of absorbing water from the environment, is determined primarily by the sugar component, but can be influenced by an aggregate, when appropriate. Some sugars or sugar alcohols are strongly hygroscopic, i.e., they absorb already at a low relative humidity of the ambient air (RH). This characteristic is generally described in the literature, or the person skilled in the art can determine it by common methods.

For the application according to the invention, hygroscopic sugar components are often less suitable, since the glass transition temperature drops with an uncontrolled absorption of water (see https://de.wikipedia.org/wiki/Gordon-Taylor-Gleichung; “Critical water activity of disaccharide/maltodextrin blends”; Sillick, Gregson, Carbohydrate Polymers 79 (2010) 1028-1033), and if it drops below room temperature, the sugar or sugar alcohol changes from a glass to a plastically deformable and rubbery state. As a result, the properties of a compact three-dimensional structure made of a moulding composition containing such sugar components are less suitable for some applications. If the mould has a relatively large surface area, is exposed to moist air for a relatively short time or not at all and/or the application allows for a tolerance where appropriate, moulding compositions with hygroscopic properties may also be suitable.

As examples of strongly hygroscopic sugars or sugar alcohols, D-fructose, D-sorbitol and D-lactose and, to a lesser extent, also D-glucose may be mentioned. For example, the sugars and sugar alcohols sucrose (from 85% RH), D-trehalose (from 92% RH), maltitol (from 80% RH) and xylitol (from 80% RH), which have already been mentioned, are weakly hygroscopic and thus preferred. The sugar alcohols erythritol, lactitol and mannitol are not hygroscopic. Mixtures (e.g., eutectic mixtures) of hygroscopic sugars and/or sugar alcohols with non-hygroscopic sugars and/or sugar alcohols are not hygroscopic per se and may therefore be preferred.

TABLE 3
Properties for various sugar components

| Sugar | empirical | | | | mp* |
|---|---|---|---|---|---|
| component | formula | class | reducing | hygroscopic | (° C.) |
| sucrose | C₁₂H₂₂O₁₁ | disaccharide | yes | weak, from | 160-186 |
| | | | | 85% RH | |
| D-glucose | C₆H₁₂O₆ | monosaccharide | yes | weak, from | 146 |
| | | | | 90% RH⁵ | |
| D-glucose | C₆H₁₂O₆•H₂O | hydrate of a | yes | yes | 83-864 |
| monohydrate | | monosacchande | | | |
| fructose | C₆H₁₂O₆ | monosaccharide | yes | strong | 106 |
| maltose | C₁₂H₂₂O₁₁ | disaccharide | yes | | 160-165⁴ |
| maltose | C₁₂H₂₂O₁₁•H₂O | hydrate of a | yes | | 102-103⁴ |
| monohydrate | | disaccharide | | | |
| mannose | C₆H₁₂O₆ | monosaccharide | yes | | 132-133⁴ |
| α-D-galactose | C₆H₁₂O₆ | monosaccharide | yes | | 167⁴ |
| β-D-galactose | C₆H₁₂O₆ | monosaccharide | yes | | 143-145⁴ |
| lactose | C₁₂H₂₂O₁₁ | disaccharide | yes | very weak, | 232⁶ |
| | | | | from | |
| | | | | 80% RH | |
| trehalose | C₁₂H₂₂O₁₁ | disaccharide | no | weak, from | 214-216¹ |
| | | | | 92% RH | |
| erythritol | C₄H₁₀O₄ | sugar alcohol | no | no | 122 |
| sorbitol | C₆H₁₄O₆ | sugar alcohol | no | strong | |
| mannitol | C₆H₁₄O₆ | sugar alcohol | no | no | 165-168² |
| maltitol | C₁₂H₂₄O₁₁ | sugar alcohol | no | weak, from | 148-151 |
| | | | | 80% RH | |
| xylitol | C₆H₁₄O₆ | sugar alcohol | no | weak, from | 93-94.5 |
| | | | | 80% RH | |
| isomalt | C₁₂H₂₄O₁₁ | sugar alcohol | no | no | 145-150 |
| | | mixture | | | |
| lactitol | C₁₂H₂₄O₁₁ | sugar alcohol | no | no | |
| α-cyclodextrin | C₃₆H₆₀O₃₀ | oligosaccharide | no | no | 277³ |
| sucrose | | eutectic | yes | presumably | 137 |
| (30 wt %)- | | monosaccharide | | average | |
| glucose | | mixture | | | |
| glucose | | eutectic | yes | presumably | 93.2 |
| (27 wt%)- | | monosaccharide | | strong | |
| fructose | | mixture | | | |
| sucrose | | eutectic | yes | presumably | 97 |
| (30 wt %)- | | monosaccharide | | strong | |
| fructose | | mixture | | | |

*Melting point or decomposition range.
¹Molecules 2008, 13(8), 1773-1816.
²G. Kumaresan, R. Velraj and S. Iniyan, 2011. Thermal Analysis of D-mannitol for Use as Phase Change Material for Latent Heat Storage. Journal of Applied Sciences, 11: 3044-3048.
³https://cameochemicals.noaa.govichemica1/20064 (retrieved December 2018).
⁴Römpp Online 4.0, https://roempp.thieme.de (retrieved December 2018).
⁵B.J. Donnelly, J.C. Fruin, and B.L. Scallet. 1973 Reactions of Oligosaccharides. III. Hygroscopic Properties. Cereal Chem 50:512-519.
⁶Peter C. Schmidt, Siegfried Lang, Pharmazeutische Hilfsstoffe 2013: mp 223° C. (pure anhydrous alpha-lactose), mp 252.2° C. (pure anhydrous beta-lactose), mp 232.0° C. (typical commercial product).

In a further embodiment, it is preferred that the moulding composition according to the invention furthermore comprises water, preferably water in a weight proportion of at most 10% in relation to the weight of the moulding composition.

In particular when the mould was produced from a cooled melt, the addition of small amounts of water to the moulding composition already showed a significant improvement in the elastic properties, i.e., in comparison to the moulds made of the corresponding moulding compositions without water, the moulds made of the water-containing moulding composition displayed a better resistance to impact or breakage upon scratching (see Example 2).

A further component of the moulding composition according to the invention is the aggregate. The aggregate is preferably included in a weight proportion of at most 20%, preferably at most 10%, in relation to the weight of the moulding composition.

For the moulding composition according to the invention, the following compositions result, inter alia, for the weight proportions of the three above-described components:
Sugar component: approx. 70% to approx. 99%, preferably approx. 85% to approx. 99%
Aggregate: approx. 1% to approx. 20%, preferably approx. 1% to approx. 10%
Water: 0% to approx. 10%, preferably approx. 0% to approx. 5%

A weight proportion starting from a value of 0% implies that this component is not included in the composition (0%) or is included therein (>0%). The weight proportions in % are, in each case, indicated as weight proportions of the total mass of the moulding composition (m/m).

An aggregate can be in powder or fibre form or in another form, with the aggregate preferably being provided solid at room temperature and in particles, which means that it can be provided as a fibre or powder, for example. The aggregate is preferably used with a fibre length or grain size of <5 mm, for example, as a fibre having a length of 0.2 mm to 3 mm. In such sizes, the aggregate can be distributed properly, i.e., evenly, in the moulding composition. In a preferred embodiment, the at least one aggregate is powdery or fibrous.

The aggregate has a considerable effect on the mechanical properties of moulds made of the moulding composition according to the invention even in small amounts (see Examples 1 C and 1 D). The aggregate prevents, among other things, the susceptibility to break or, respectively, to shatter under sudden stress, which is typical of glass-like bodies. The precise mechanism of how this effect is achieved remains unclear. Since, both crystalline and amorphous areas are to be expected in the structure due to the sugar component, the mechanical properties can vary solely because of an impact on the distribution or, respectively, the limits of those areas.

The inventors have examined various materials and moulds for the aggregate, and the benefits become apparent for a wide variety of materials and moulds (Example 1 C-D).

In general, it is anticipated by the inventors that especially such materials are well suited as aggregates, which materials are provided as solids, have good mechanical properties (high compressive and/or tensile strength) and enter into interactions with the sugar component, such as electrostatic interactions (e.g., ion-dipole interactions) and/or hydrogen bonds, but also weak interactions such as Van der Waals interactions and hydrophobic interactions.

It is preferred that the aggregate is not soluble in the sugar component or is not dissolved during the manufacture of the mould. Thus, the moulding composition is preferably a heterogeneous mixture, with the aggregate being selected such that it can be distributed evenly in the sugar component or, respectively, in the melt of the sugar component.

In this connection, both lipophilic materials such as carbon (charcoal) or polyethylene and hydrophilic materials such as cellulose are suitable as aggregates. In contrast, materials that are both hydrophobic and lipophobic, such as perfluorinated polymers (e.g., polytetrafluoroethylene and polyvinylidene fluoride), have proved to be less suitable. For such materials, no or hardly any interactions with a sugar component are to be expected. For example, the wetting angle of contact between the material of the aggregate and the liquefied sugar component, which is preferably smaller than 160°, more preferably smaller than 120°, may be regarded as a relevant criterion.

It is also preferred that the aggregate displays good thermal stability. In one embodiment, the aggregate has a melting point or a thermal decomposition point which is higher than that of the sugar component, which means that the aggregate is solid also during the manufacture of a mould by melting and does not thermally decompose.

Suitable materials for the aggregate can be those that are known to a person skilled in the art, for example, as fillers and/or reinforcing materials in connection with plastic materials (described, for example, in DIN EN ISO 1043-2:2012-03 Kunststoffe Teil 2: Füllstoffe und Verstärkungsstoffe) or, respectively, as fibre materials in fibre composites (described, for example, in https://de.wikipedia.org/wiki/Faserverbundwerkstoff) such as fibre-plastic composites (described, for example, in https://de.wikipedia.org/wiki/Faser-Kunststoff-Verbund).

Known fillers and reinforcing materials are selected, for example, from the group consisting of aramid, boron, carbon (crystalline, semi-crystalline or amorphous, e.g., carbon fibre, graphite, carbon blacks, activated carbon, graphene), aluminium hydroxide, aluminium oxide, clay, glass, calcium carbonate, cellulose, metals, mineral, organic natural substances such as cotton, sisal, hemp, flax etc., mica, silicate, synthetic organic substances (e.g., polyethylene, polyimides), thermosetting materials, talc, wood, chalk, sand, diatomaceous earth, zinc oxide, titanium dioxide, zirconium dioxide, quartz, starch.

Known fibrous aggregates are selected, for example, from the group consisting of inorganic reinforcing fibres (such as, e.g., basalt fibres, boron fibres, glass fibres, ceramic fibres, quartz fibres, silica fibres), metallic reinforcing fibres (e.g., steel fibres), organic reinforcing fibres (e.g., aramid fibres, carbon fibres, PBO fibres, polyester fibres, nylon fibres, polyethylene fibres, polymethyl methacrylate fibres), and natural fibres (e.g., flax fibres, hemp fibres, wood fibres, sisal fibres, cotton fibres and products made of those fibres and modified by chemical and/or physical treatment).

Preferably, only one aggregate is used in the moulding composition according to the invention, i.e., one material in one form (e.g., a powder or fibre). It is not ruled out, however, that the moulding composition comprises several aggregates, that is to say, for example, aggregates made of different materials and/or in different forms.

In a preferred embodiment, the at least one aggregate is selected from the group consisting of cellulose, carbon (charcoal), glass, aramid, aluminium oxide, silicon dioxide and polyethylene, preferably cellulose and carbon, more preferably glass, cellulose and carbon fibres.

The mould according to the invention, which is suitable for use in a moulding process, is a compact three-dimensional structure made of the moulding composition according to the invention. The term compact three-dimensional structure is intended to express that the mould forms a dimensionally stable body of a specific shape/geometry. This body is formed preferably uniformly, consistently from the moulding composition.

In the mould according to the invention, the heterogeneous character of the moulding composition can be visible also macroscopically or under the light microscope. In one embodiment, this is a heterogeneous (two-phase) structure in which the aggregate is present as a dispersed phase, being distributed in the sugar component (as a continuous phase or matrix).

For the mould according to the invention, which is a structure made of the moulding composition according to the invention, weight proportions are to be expected which correspond to those of the moulding composition. However, fluctuations between the composition and the mould may occur naturally. For example, the proportion of water may decrease during the production of the mould due to the evaporation of water compared to the moulding composition and, thus, can be lower in the mould.

In order to obtain a structure, the components of the moulding composition are provided, mixed and shaped into a three-dimensional body. The final step of this process of producing the mould can be accomplished in at least two different ways.

The moulding composition is preferably introduced as a melt into a further three-dimensional casting mould, which constitutes a negative of the three-dimensional body the mould according to the invention is supposed to assume, and is cooled. The melt is obtained by heating the moulding composition to a temperature in the range of the melting point, preferably beyond the melting point, of the sugar component. The liquefied moulding composition can then be moulded by casting. For moulding the melt, silicone moulds, for example, are suitable as casting moulds, which, due to their elasticity, can be removed even from complex three-dimensional structures as soon as the latter have cooled down and are thus solid. In this case, the structure is a cooled melt. Cooled melts of a sugar component are also referred to as sugar glass. Such processes for producing three-dimensional structures from cooled melts are known, for example, from the field of food production (e.g., for hard caramels or sugar decorations) and, as shown herein, can be used not only for sugar components but also for moulding compositions which, furthermore, contain an aggregate.

Further modifications, in which a structure consisting of a melt is produced from the moulding composition by means of injection moulding or 3D printing, are conceivable to a person skilled in the art.

Alternatively, the moulding composition can be moulded into a three-dimensional structure also by means of pressing. It is known from the pharmaceutical industry, for example, that sugar components can be formed into compact three-dimensional structures by means of pressure. In this case, the structure is a compressed structure. Cohesive forces, adhesive forces, solid bridges or form-fitting bonds are considered for the cohesion in the compressed structure or the pressed material, respectively (Bauer K. H., Frömming K.-H., Führer C. Pharmazeutische Technologie, 5^{th} edition, 1997, Gustav Fischer Verlag, page 332 “Bindung in Tabletten”). The production of the mould by means of pressing will be preferred especially for moulds which have a relatively simple three-dimensional shape.

In a preferred embodiment, for the mould according to the invention and also that in the process for moulding a workpiece, the structure is a melt or a compressed structure of the moulding composition.

The process according to the invention for moulding a workpiece, comprising the steps of
providing at least one mould according to the invention,
contacting the mould with a material to be moulded,
hardening the material to be moulded in order to obtain the workpiece,
removing the mould from the workpiece.

In one embodiment, the process for moulding a workpiece can be used in the course of
1. a lost core injection moulding process,
2. a powder injection moulding process,
3. a pressing process,
4. a production of a fibre-plastic composite material by means of lamination, or
5. a production of a ceramic mould shell for investment casting.

The types of moulding processes (1.-5.) that have already been described above are basically known. In those processes, the mould according to the invention, which is a compact three-dimensional structure made of the moulding composition according to the invention, can replace the known moulds, in particular the known lost moulds. Embodiments with regard to the workpieces, the materials to be moulded, hardening steps and, possible post-treatments respectively, thus become evident in part from the prior art.

The material to be moulded is preferably provided in a flowable, free-flowing or at least plastically deformable state for being contacted with the mould or, when appropriate, several moulds so that a tight fit between the material and the mould is achieved when the mould is being contacted and the three-dimensional configuration of the mould is transferred when the material is hardened.

In the process according to the invention, the hardening step is regarded as the step in which the mould according to the invention permanently transfers its outline to the material to be moulded. In preferred embodiments, such as during pressing and also during powder injection moulding, additional steps for further processing of the initially obtained workpiece (green body) may also be provided, which are also (can also be) referred to as hardening steps, but are to be distinguished from the hardening step according to the invention.

The hardening of the material can be effected in different ways depending on the type of moulding process. Hardening preferably occurs in a mechanical or in a mechanical-thermal fashion.

In this embodiment, hardening is preferably effected by exerting pressure on an arrangement of mould(s) and a material to be moulded, which is created when the mould comes into contact with the material, as it occurs, for example, in the course of a pressing process, in particular an isostatic pressing process. When hardening is effected by pressure, the advantageous mechanical properties of the moulding composition play a particularly important role.

In moulding processes such as lost core injection moulding processes, powder injection moulding processes or processes for the production of fibre-plastic composite materials by means of lamination, the material to be moulded (polymer mass, feedstock or matrix material applied in layers) is often provided at an elevated temperature so that it is brought into contact with the mould in its plastic state. Hardening is then also effected by cooling (i.e., in a mechanical-thermal fashion). In case of thermal hardening, the person skilled in the art will note that, preferably, moulds according to the invention are to be used in which the sugar component has a decomposition temperature range and/or a melting point that is not significantly lower than the temperatures used during the establishment of the contact with the material.

In a preferred embodiment of the process according to the invention, the structure of the mould is destroyed when the mould is being removed.

In this embodiment, the at least one mould according to the invention, which is a compact three-dimensional structure made of a moulding composition according to the invention, is thus a so-called lost mould. It loses at least its three-dimensional configuration, shape or geometry, i.e., the structure, after the transfer to the material has taken place. Optionally, the components of the moulding composition are also decomposed during the destruction. The at least one mould of the process can be removed by various process steps due to the sugar component, which is an essential or, respectively, the main component of the moulding composition.

The mould can preferably be removed by
dissolving the moulding composition with a hydrophilic solvent, preferably water,
melting the sugar component by heating and, when appropriate, pouring off the moulding composition,
decomposing the sugar component by heating and, when appropriate, shaking out the moulding composition (gasification),
or a combination of those measures.

In all cases, the structure of the mould is destroyed and the moulding composition can be removed with the aggregate. Dissolution and melting are preferred, whereby the mould is removed in the liquid state. Dissolution is preferred with workpieces that are thermally sensitive, since elevated temperatures do not have to be applied in this case. On the other hand, the removal of the mould by melting can be advantageous if the further processing of the workpiece involves a thermal treatment anyway. For ceramic and metallic workpieces, a further thermal hardening step (sintering) is often provided after the initial hardening, i.e., the production of a green body, which hardening step can be accompanied by the removal of the mould from the workpiece in the process according to the invention. The decomposition of the sugar component usually requires a higher temperature in comparison to melting and is therefore less preferred, but can be properly applied for removing possible residues that have not yet been completely removed by melting. During decomposition, the moulding composition is removed at least partially in the gaseous state, i.e., in this way, a removal from cavities that are particularly difficult to access is possible as well.

In the processes according to the invention, the at least one mould according to the invention is preferably used as an internally located mould. An internally located mould is also referred to as a mould core or a support structure and forms the internal product geometry of a workpiece to be moulded.

In this embodiment, an external mould can be used in addition, which preferably consists of a different material than the mould according to the invention. The external mould can also have a multipart design, e.g., a divided permanent mould. In the implementation of the process in which a further mould is used, an arrangement is formed when the moulds are brought into contact with the material, wherein a major part, preferably more than 80%, of the entire outer surface of the mould is in contact with the material to be moulded. The mould according to the invention is thus at least partially enclosed by the material during contacting with the material. It forms a model of a cavity in the workpiece to be moulded, while an additional external mould constitutes a negative external model of the workpiece to be moulded.

Experiments are shown below which illustrate compositions according to the invention and/or are helpful for understanding the invention. It is understood that the embodiments are exemplary.

The figures show stages of a process for moulding a workpiece, in detail:

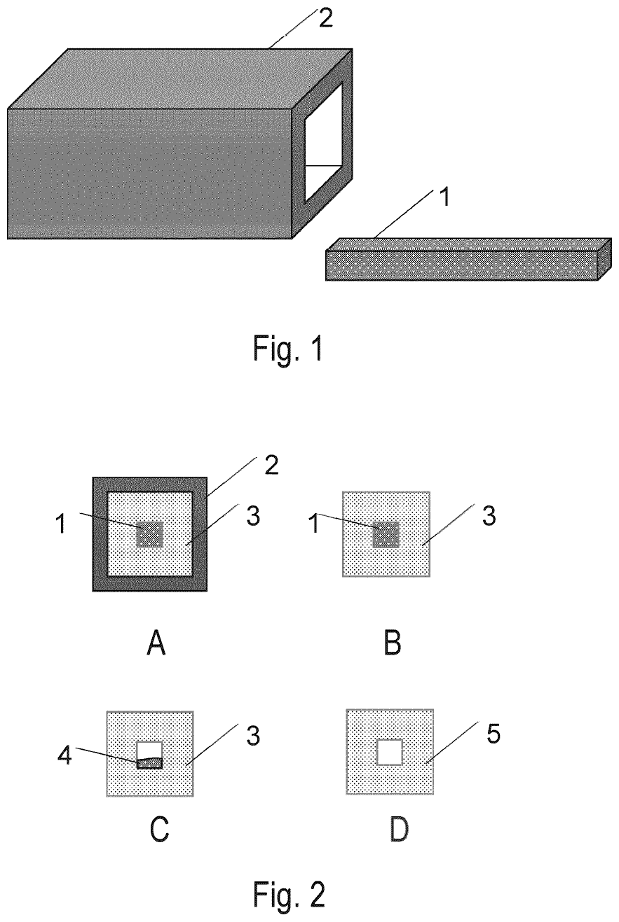

FIG. 1 shows, in a side view, two moulds, namely an internally located mould and an external mould,

FIG. 2 shows, in cross-section, the moulds being contacted with a material to be moulded before hardening (A), after hardening (B) and removing the external mould, and after post-hardening (C) and complete removal of the mould from the workpiece (D), and

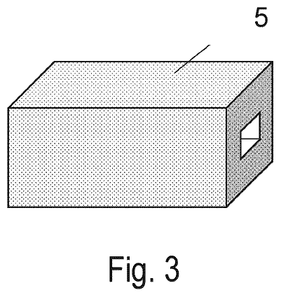

FIG. 3 shows the moulded workpiece in a side view.

### Example 1-Production and Characterization of Moulds

### A. Production of Moulds (Test Bars)

Two different types of sugar were used for the test measurements. Commercially available isomalt (“Isomalt ST-M”, Beneo GmbH), on the one hand, and a mixture of sucrose (“Wiener Feinkristallzucker”, Agrana Zucker GmbH) and glucose (“Dextropur”, Dextro Energy GmbH & Co. KG), on the other hand, were used.

Isomalt ST-M contains approx. 2.5 wt % of water and was melted at 155° C. over night in closed aluminium containers in order to keep the water content constant during the melting process. The sucrose/glucose mixture was mixed with water at a ratio of 62 wt % of sucrose, 14 wt % of glucose and 24 wt % of water (known as “sugar boiling”). The sugar mixture was heated up to a temperature of 150° C. in a beaker (1000 ml, low-form) on a heatable laboratory magnetic stirrer under vigorous stirring (with considerable amounts of water evaporating), and then the resulting melt was processed further immediately. The melt thus obtained typically contains 2-3 wt % of water.

On the basis of those two sugar melts (“Isomalt ST-M” and sucrose/glucose), test bars having dimensions of 4.7 cm×2.5 cm×1.0 cm (haptic tests) and 7.0 cm×3.8 cm×3.5 cm (measurement of strengths and modulus of deformability) were then produced in series, with commercially available silicone moulds being used as negative moulds.

### B. Characterization of Moulds Without Aggregate

It was found that especially Isomalt ST-M was very brittle after casting and cooling so that the test bodies obviously had very high strengths (breaking by hand impossible), but after scratching or punctually damaging the surface with a sharp object, the test body could be broken very easily; furthermore, after a short and fast blow with a hard object (e.g., with a screwdriver), the test body shattered into numerous pieces just like glass. In this connection, it was also observed that test bodies made of Isomalt ST-M exhibited very strong variations with regard to those properties as described, which might indicate thermal stresses.

Therefore, an attempt was then made to remove those stresses by tempering. For this purpose, the produced test bodies were cooled once under ambient conditions (room temperature), once kept at 40° C. (24 h) and once hardened in the refrigerator (4° C., 24 h) in order to highlight differences. The hardness of the differently produced test bodies was evaluated haptically (breaking by hand, scratching the surface and breaking by hand, fast blow). However, tempering the test bodies obviously had no positive effect on the hardness and brittleness as well as the variations of those properties of the examined test bodies.

In a further test series, Isomalt ST-M was melted in a closed vessel and mixed with water in order to obtain water contents of 5 wt % or 10 wt %, respectively. Furthermore, Isomalt ST-M was melted in an open vessel in order to obtain a water content of 0 wt %. With the different types of Isomalt ST-M (0, 2.5, 5, 10 wt % of water), test bodies were produced, which, in turn, were subsequently assessed haptically for their hardness. The test bodies with higher water contents (5 wt % or 10 wt % respectively) were significantly softer than standard Isomalt ST-M, obviously no longer brittle, but unfortunately no longer strong enough, either, because they could be deformed or broken by hand comparatively easily. The test bodies without water were highly susceptible to impacts or mechanical stress, which suggests increased brittleness.

In a further analogous test series with a sucrose/glucose mixture, the same effect or, respectively, trend was observed as with Isomalt ST-M.

Furthermore, when working with and storing test bodies made of Isomalt ST-M in comparison to sucrose/glucose mixtures, significant differences could be determined with regard to hygroscopicity: While, in practice, the former showed a negligible tendency to absorb water, a sticky consistency was observed on sucrose/glucose test bodies within a short time upon contact with the open atmosphere, which sticky consistency led to a progressive plasticization of the surface of the test bodies within hours so that they became unusable. In practice, moulds made of sucrose/glucose would therefore have to be processed immediately or packaged in an airtight manner for storage, especially in case of increased air humidity.

### C. Haptic Specification of Moulds Made of a Moulding Composition With an Aggregate

In a test series, the various aggregates (Table 4) were examined with Isomalt ST-M and sucrose-glucose (as described above) as the matrix (sugar component).

TABLE 4
Examined aggregates

| Aggregate | Source of supply |
|---|---|
| activated carbon Norit ® CASPF | Cabot Corporation, Alpharetta Georgia, USA |
| aramid-fibre filler F AR 700/250 | Schwarzwälder Textil-Werke, Schenkenzell, |
| (1.5 mm) | Germany |
| calcium carbonate powder, no. 21060 | Merck KGaA, Darmstadt, Germany¹ |
| carbon-filler SFR 0.20 MFC (0.2 mm) | Schwarzwälder Textil-Werke, Schenkenzell, |
| | Germany |
| carbon-short cut SFC 3 EPB (3 mm) | Schwarzwälder Textil-Werke, Schenkenzell, |
| | Germany |
| cellulose fibre medium, no. C6288 | Merck KGaA, Darmstadt, Germany¹ |
| glass fibre-short cut FGCS ECR 416/3 | Schwarzwälder Textil-Werke, Schenkenzell, |
| (3 mm) | Germany |
| glass fibre ground no. 2101101 (0.2 mm) | R&G GmbH, Waldenbruch, Germany |
| glass fibre cuttings no. 2101001 (3 mm) | R&G GmbH, Waldenbruch, Germany |
| carbon fibre ground no. 2101351 | R&G GmbH, Waldenbruch, Germany |
| (0.2 mm) | |
| carbon fibre cuttings no. 210137-NA-2 | R&G GmbH, Waldenbruch, Germany |
| (3 mm) | |
| polyethylene powder, no. 434272 | Merck KGaA, Darmstadt, Germany¹ |
| polytetrafluoroethylene powder, no. | Merck KGaA, Darmstadt, Germany¹ |
| 430935 | |
| polyvinylidene fluoride powder, no. | Merck KGaA, Darmstadt, Germany¹ |
| 182702 | |
| titanium (IV) oxide powder, no. T8141 | Merck KGaA, Darmstadt, Germany¹ |
| silica gel 60 powder, no. 60738 | Merck KGaA, Darmstadt, Germany¹ |
| aluminium oxide powder, no. 06320 | Merck KGaA, Darmstadt, Germany¹ |

¹ordered via Sigma-Aldrich, Inc.

For the production of the moulding composition, an appropriate amount of Isomalt ST-M was melted as described above, provided with the appropriate amount of aggregate and carefully distributed evenly in a beaker with a glass rod. The amount of aggregate was restricted to a maximum of 10 wt %, but some aggregates could only be distributed evenly in the sugar matrix in smaller quantities.

In order to prevent premature hardening of the material, the produced mixture was quickly poured into appropriate silicone moulds and small test bars were produced (4.7 cm×2.5 cm×1 cm). The mechanical properties of the test bars were haptically evaluated analogously to the process described above (breaking by hand, scratching the surface and breaking by hand, fast blow) and compared to the properties of the corresponding mould made of the sugar component alone (Table 5).

TABLE 5
Results of the haptic-mechanical testing of sugar bars with various aggregates.

| | comparison to a sugar |
|---|---|
| Composition | matrix without aggregate |
| Isomalt ST-M + 10 wt % of activated carbon | strongly improved properties |
| Isomalt ST-M + 0.5 wt % of aramid | improved properties |
| Isomalt ST-M + 10 wt % of calcium carbonate | improved properties |
| Isomalt ST-M + 2 wt % of carbon-filler SFR | strongly improved properties |
| Isomalt ST-M + 2 wt % of carbon-short cut | strongly improved properties |
| Isomalt ST-M + 10 wt % of cellulose fibre | strongly improved properties |
| Isomalt ST-M + 10 wt % of glass fibre (0.2 mm) | improved properties |
| Isomalt ST-M + 10 wt % of glass fibre (3 mm) | improved properties |
| Isomalt ST-M + 10 wt % of carbon fibre (0.2 mm) | strongly improved properties |
| Isomalt ST-M + 2 wt % of carbon fibre (3 mm) | strongly improved properties |
| Isomalt ST-M + 10 wt % of polyethylene | strongly improved properties |
| Isomalt ST-M + 10 wt % of polytetrafluoroethylene | substantially poorer |
| | properties |
| Isomalt ST-M + 10 wt % of polyvinylidene fluoride | substantially poorer |
| | properties |
| Isomalt ST-M + 10 wt % of titanium(IV)oxide | improved properties |
| Isomalt ST-M + 10 wt % of silica gel 60 powder | strongly improved properties |
| Isomalt ST-M + aluminium oxide powder | strongly improved properties |
| sucrose-glucose + 10 wt % of cellulose | strongly improved properties |

### D. Mechanical Specification of Moulds Made of a Moulding Composition With an Aggregate

Larger test bars (7.0 cm×3.8 cm×3.5 cm) were produced from some candidates that had performed better in the haptic tests compared to the sugar matrix without additives. Compressive strength, flexural strength and modulus of deformability were measured for each of those as described. A test system from Form & Test Prüfsysteme was used for determining the compressive strengths (www.formtest.de). Model: DigiMaxx C-20, max. piston stroke 15 mm, max. force 600 kN, and feed pressure 1 MPa/s according to DIN EN 993-5 (1998). For the measurements, test bars with the following dimensions were cast: 7 cm×3.8 cm×3.5 cm.

For determining the flexural strength or, respectively, the modulus of deformability, a flexural strength machine from Messphysik (www.messphysik.com, Model Midi 5) with a measuring cell of up to 500 kN was used. In this case, the operation was performed with a feed pressure of 0.15 MPa/s (according to DIN EN 993-6, 1995). The def-modulus (also modulus of deformability) is related to the modulus of elasticity and, like the modulus of elasticity, is the first derivative of the stress with respect to expansion or, respectively, deformation. In this connection, the modulus of deformability is determined by establishing a regression line in the area of the curve at ε_{Br}/2, wherein ε_{Br} is the deformation that occurs at break.

The results of the corresponding measurements are shown in Table 6 below:

TABLE 6
Results for compressive and flexural strengths and modulus of deformability
(±standard deviation absolute and relative) for various moulding compositions
(measured as bars)

| | compressive | flexural | modulus of |
|---|---|---|---|
| | strength | strength | deformability |
| Composition | [N/mm²] | [N/mm²] | [N/mm²] |
| Isomalt ST-M | 4.4 ± 2.5 (±57%) | 14.0 ± 15.3 (±109%) | 2464 ± 2549 (±103%) |
| Isomalt ST-M + 10 wt % | 29.9 ± 17.7 (±59%) | 13.4 ± 4.1 (±31%) | 2381 ± 1562 (±66%) |
| of cellulose | | | |
| Isomalt ST-M + 10 wt % | 49.6 ± 12 (±24%) | 7.2 ± 4.3 (±60%) | 2060 ± 883 (±42%) |
| of glass fibre (0.2 mm) | | | |
| Isomalt ST-M + 10 wt % | 42.3 ± 6.7 (±16%) | 7.2 ± 0.7 (±10%) | 1990 ± 146 (±7%) |
| of glass fibre (3 mm) | | | |
| Isomalt ST-M + 10 wt % | 79.9 ± 13.2 (±17%) | 20.5 ± 3.8 (±19%) | 3596 ± 1294 (±36%) |
| of carbon fibre (powder) | | | |
| Isomalt ST-M + 2 wt % | 27.7 ± 9.6 (±35%) | 8.8 ± 0.4 (±5%) | 3435 ± 451 (±13%) |
| of carbon fibre (3 mm) | | | |
| Isomalt ST-M + 0.5 wt % | 11.1 ± 5.1 (±46%) | 5.7 ± 2 (±35%) | 3686 ± 2266 (±61%) |
| of aramid filler | | | |
| Isomalt ST-M + 10 wt % | 20.2 ± 8.8 (±43%) | 3.2 ± 0.4 (±13%) | 1335 ± 212 (±16%) |
| of polyethylene | | | |
| sucrose-glucose | 9.9 ± 8.9 (±90%) | 5.3 ± 0.7 (±13%) | 290 ± 231 (±80%) |
| sucrose-glucose + 10 | 37.7 ± 5.7 (±15%) | 7.7 ± 1.5 (±19%) | 1377 ± 469 (±34%) |
| wt % of cellulose | | | |

It was observed that, in comparison to the pure sugar component—but also in comparison to a moulding composition made of a sugar component and water—the compressive strength is increased for all examined aggregate and, respectively, sugar components. The moulding compositions according to the invention are therefore more suitable for processes in which a high compressive strength is required.

The flexural strength shows a very high scattering for moulds made of isomalt, which is indicative of mechanical stresses within the mould. By means of the aggregates, even though a quantitative effect on the flexural strength is not achieved for all materials, it was found that the variation was reduced between different measurements. The better reproducibility of the flexural strength amounts to an optimization of the mechanical properties of the moulds in comparison to those without an aggregate. For some moulding compositions (with cellulose and powdered carbon fibres), flexural strengths are achieved that are comparable in terms of magnitude to the tensile strengths of metallic fusible alloys (cf. Table 1).

The addition of an aggregate shows different effects on the modulus of deformability, depending on the sugar component. For isomalt, the modulus of deformability tends to decrease, i.e., elasticity is increased, but especially a reduction in the variation is achieved also in this case. For sucrose/glucose, the aggregate (10 wt % of cellulose) has an opposite effect. In both cases, however, the modulus of deformability achieved with an aggregate is in the order of magnitude of the modulus of elasticity specified for plastic materials that are used as lost moulds (cf. Table 2).

### Example 2-Process for Moulding a Ceramic Workpiece

Technical ceramics are often produced using isostatic pressing (see also point 3 above). The mould according to the invention was used in such a process as an internally located mould within the ceramic pressed part, which is to be described herein in further detail with reference to the figures.

At first (FIG. 1), a mould 1 according to the invention was produced, as described in Example 1, from a moulding composition by means of melting and casting into a silicone mould with isomalt STM as the sugar component and carbon fibre (ground carbon fibre) as the aggregate. The moulding composition was brought to 160° C. in a controlled manner (5 hours), stirred with a simple laboratory mixer and poured out into a new silicone mould (20×15×120 mm). Upon cooling of the melt, a high-strength and stiff cast arises, i.e., the bar-shaped mould 1. In addition, an external rubber mould 2 was provided, in which the mould according to the invention is arranged centrally.

In the second step (FIG. 2A), a ceramic granulate material 3 was poured into the external mould as the material to be moulded so that an arrangement according to FIG. 2B was created. The external mould is filled up to the edge. The ceramic granulate material was based on alumina graphite with a resin binder.

The rubber mould is closed with a complementary rubber mould and wrapped in a waterproof sheet. The arrangement was then pressed by means of water pressure of 360 bar.

The rubber mould 2 could be removed easily due to its flexibility. The ceramic mass 3 encloses the mould 1 after the pressing process without any visible deformation of the mould (FIG. 2 B)

In order to remove the mould 2, the arrangement is heated to 240° C. in a hardening oven and, in doing so, the moulding composition 4 flows out of the workpiece 3 to be moulded incompletely, with the mould 2 being lost. The residues can be dissolved in the water or only after the subsequent firing.

Hardening is followed by firing, wherein the product is heated to 1000° C. under reductive conditions. In doing so, all of the residues evaporate for the most part, and only small amounts of ash remain in the product 5 (FIG. 2 D). They can be removed easily by means of a water jet.

The final product 5 (see also FIG. 3) can assume an internal geometry of varying complexity by means of this technology. The slight shrinkage of the resulting cavity is due to the shrinkage of the ceramic material used, rather than due to the deformation of the meltable tool. Therefore, the shrinkage can be taken into account when planning the final geometry in order to achieve a precise geometry.

1. A moulding composition comprising
at least one sugar component in a weight proportion of at least 20% in relation to the weight of the moulding composition, and
at least one aggregate.

2. A moulding composition according to claim 1, wherein the at least one sugar component is selected from the group consisting of monosaccharides, disaccharides, oligosaccharides, sugar alcohols derived from a monosaccharide, a disaccharide or an oligosaccharide, hydrates thereof and mixtures thereof.

3. A moulding composition according to claim 1, wherein the at least one sugar component is a compound of the general formula I
$${C}_{( n * a )} {H}_{( n * a * 2 ) + 2 b - 2 c} {O}_{( n * a ) - c} , \qquad ( I )$$
wherein
n is 1 to 10, preferably 1 or 2,
a is 4, 5 or 6,
b is 0 or 1, and
c is n-1 or n,
a hydrate of a compound of general formula I or a mixture of at least two compounds of general formula I and/or hydrates thereof.

4. A moulding composition according to claim 1, wherein the at least one sugar component is selected from the group consisting of sucrose, D-fructose, D-glucose, D-trehalose, cyclodextrins, erythritol, isomalt, lactitol, maltitol, mannitol, xylitol and mixtures thereof, particularly preferably D-trehalose, isomalt, erythritol, lactitol, mannitol and eutectic mixtures of sucrose and D-glucose.

5. A moulding composition according to claim 1, wherein the at least one sugar component has a melting point and a decomposition temperature range, wherein the melting point is below the decomposition temperature range.

6. A moulding composition according to claim 1, wherein the moulding composition furthermore comprises water, preferably water in a weight proportion of at most 10% in relation to the weight of the moulding composition.

7. A moulding composition according to claim 1, wherein the at least one sugar component is not hygroscopic or is hygroscopic only above a relative humidity of 80%.

8. A moulding composition according to claim 1, wherein the at least one aggregate is included in a weight proportion of at most 20%, in relation to the weight of the moulding composition.

9. A moulding composition according to claim 1, wherein the at least one aggregate is included in a weight proportion of at most 10%, in relation to the weight of the moulding composition.

10. A moulding composition according to claim 1, wherein the at least one aggregate is powdery or fibrous.

11. A moulding composition according to claim 1, wherein the at least one aggregate is selected from the group consisting of cellulose, carbon, glass fibre, aramid, aluminium oxide, silicon dioxide and polyethylene, preferably cellulose and carbon.

12. A moulding composition according to claim 1, wherein at least one sugar component is in a weight proportion of at least 50%, in relation to the weight of the moulding composition.

13. A moulding composition according to claim 1, wherein at least one sugar component is in a weight proportion of at least 80%, in relation to the weight of the moulding composition.

14. A mould for a moulding process, wherein the mould is a compact three-dimensional structure made of a moulding composition according to claim 1.

15. A mould according to claim 14, wherein the structure is a melt or a compressed structure of the moulding composition.

16. A mould according to claim 14, wherein the mould is a heterogeneous structure in which the aggregate is present as a dispersed phase, being distributed in the sugar component.

17. A process for moulding a workpiece, comprising the steps of
providing at least one mould according to claim 14,
contacting the mould with a material to be moulded,
hardening the material to be moulded in order to obtain the workpiece,
removing the mould from the workpiece.

18. A process according to claim 17, wherein the structure of the mould is destroyed during removing.

19. A process according to claim 18, wherein destroying the structure of the mould is effected by
melting the sugar component by heating and removing, in particular pouring off, the moulding composition,
dissolving the moulding composition with a hydrophilic solvent, preferably water,
decomposing the sugar component by heating and optionally removing residues of the moulding composition,
or a combination of those measures.

20. A process according to claim 17, wherein during contacting the at least one mould comes to lie within the material to be moulded and, optionally, a further mould is contacted with the material to be moulded from the outside.

21. A process according to claim 17, wherein the process for moulding a workpiece is used in the course of
a production of a ceramic mould shell for investment casting,
a lost core injection moulding process,
a powder injection moulding process,
a pressing process, or
a production of a fibre-plastic composite material by means of lamination.

22. A process according to claim 17, wherein hardening to obtain the workpiece occurs mechanically. preferably by exerting pressure on an arrangement of the mould and the material to be moulded. which arrangement is created by contacting the mould with the material.
